(19) United States
(12) Patent Application Publication
(10) Pub. No.: US 2019/0193156 A1
(43) Pub. Date: Jun. 27, 2019

(54) Simultaneous 3D printing and NDT with Computer Tomography using LDA

(71) Applicant: Linbo Yang, Pleasanton, CA (US)

(72) Inventor: Linbo Yang, Pleasanton, CA (US)

(21) Appl. No.: 16/199,135

(22) Filed: Nov. 24, 2018

Related U.S. Application Data
(60) Provisional application No. 62/596,790, filed on Dec. 9, 2017.

(51) Int. Cl. B22F 3/105; B29C 64/393; G06T 7/00; B29C 64/153

(52) U.S. Cl. CPC B22F 3/1055; B29C 64/393; B33Y 50/02; B29C 64/153; G06T 7/0008

(57) ABSTRACT

In accordance with some embodiments of the invention, a method of simultaneous 3D printing and Non-Destructive Testing (NDT) using Computer Tomography (CT) using Linear Diode Array (LDA) is presented. An apparatus of simultaneous 3D printing and NDT using CT with LDA comprises a 3D printer, an X-ray source, X-ray LDA detector, data acquisition system, CT reconstruction software, CT visualization software, motion control system and a computer. Either platform of 3D build or X-ray source/detector can be on a rotation and translational stage. The apparatus with the method can automatically find defects, stop current 3D printer build, replace older part and start a new object build process based on real time CT data analysis.

### FIELD OF THE INVENTION

The present invention pertains generally to the field of system and method of 3D printing and Non-Destructive Testing (NDT) with Computer Tomography (CT) using Linear Diode Array (LDA) X-ray detector.

### BACKGROUND OF THE INVENTION

3D printing, also known as additive manufacturing (AM), is a name that describes the technologies that build 3D objects by adding layer-upon-layer of material, whether the material is plastic, metal, concrete etc under computer control. Key components of AM technologies include a computer, 3D modeling software (Computer Aided Design or CAD), machine equipment and layering material.

After a CAD 3D data is produced, the AM equipment reads in data from the CAD file and lays downs or adds successive layers of liquid, powder, sheet material or other, in a layer-upon-layer fashion to fabricate a 3D object. The term AM includes many technologies including subsets like Rapid Prototyping (RP), Direct Digital Manufacturing (DDM), layered manufacturing and additive fabrication.

Just like many other manufacturing, layer-by-layer or 2D-to-3D manner of the AM process could also produce internal defects that are similar to those seen in welding and joining processes. For example, some defects include lack of fusion; gas porosity and keyhole collapse etc.

There is a problem associated with current AM process in industry.

Namely, the poor build quality is often not detected until after build completion. If post process inspection shows that part has a quality problem, it is very likely that part will be discarded. Therefore, both precious time and material are wasted in 3D printing process. There is in situ need for simultaneous 3D printing and NDT.

Non-Destructive Testing (NDT) is a wide group of analysis techniques used in science and industry to evaluate the properties of a material, component or system without causing damages. The terms Nondestructive Examination (NDE), Nondestructive Inspection (NDI), and Nondestructive Evaluation (NDE) are also commonly used to describe this technology.

As one of NDT method, X-ray computed tomography (CT) is a proven effective way to precisely locate the defects inside an object. X-ray computed tomography (CT) provides a quantitative visualization of objects layer by layer as well as in 3D and this makes the CT technology particularly useful for studying the outcome of an additive manufacturing (AM) process.

CT measurement can be useful not only for non-destructive inspection but also for the metrological assessment of additive manufactured parts, particularly by using dimensional metrology (part to CAD comparison, wall thickness analysis, size) and for material inspection (voids and defect detection). In particular, tolerances can be contrasted between different processes with non-destructive measurement of the additive manufactured product.

A CT system includes X-ray source, X-ray detector, motion control, data acquisition and image reconstruction and visualization software etc. There are two types of X-ray detector for using at a CT system: one is called panel detector, other is called LDA (Linear Diode Array) detector including multi line LDA detector.

Due to the nature of 2D area, a flat panel and cone-beam X-ray can cover much larger area of object at a time and therefore perform CT scan faster than that of LDA.

But when X-ray kV or energy increases, flat panel is susceptible to X-ray scatter problem at the object. In addition, flat panel detector always has overall panel size limitation. Plus, there may not be enough physical space for a 2D flat panel detector nearby a build platform at 3D printing system.

In contrast, a LDA has much less scatter problem. Its size can range from several centimeters to several meters in length. X-ray energy can go much higher and more suitable for larger and heavier 3D print part NDT.

There is a special advantage to use LDA detector rather than use flat panel detector in order to match AM build process.

AM process is a layer-by-layer process while fan beam CT with LDA is also a step “layer-by-layer” scan. It enables system to acquire an updated 3D image while AM build process is going on. In other words, 3D image of AM build part is constantly being updated “layer-by-layer” with a fan beam CT method. Using fan beam CT with LDA, it is also easy to locate a defect at a location of specific scan “layer”.

In current invention, we propose a method that is intended to save time and material at AM.

The AM is real manufacturing. And AM lead time is fast, but not lightning fast. During AM manufacturing, an X-ray CT system using LDA is been applied simultaneously. For this CT system, step-and-shoot working mode is sufficient in most cases.

For step-and-shoot CT, it consists of two alternative stages: data acquisition and relative positioning either from source/detector or from build platform.

During data acquisition stage, the part remains stationary at build platform and X-ray tube and detector rotates about the part to acquire a complete set of projections at a prescribed scanning location. During part relative positioning stage, no data are acquired and either part or source/detector is relatively transported to the next prescribed scanning location.

In general, electronic data acquisition is much faster than AM one layer mechanical build. Therefore, step-and-shoot CT has much more ways to improve NDT system overall performances.

First, this allows step-and-shoot CT acquire much better quality data by simply increasing detector exposure time and performing more data averaging; Second, X-ray tube requirement could be lower so that cost is lower; Third, rotation does not need to be super fast so that cost on motion control system is also lower; Fourth, data acquisition system does not need to have very high bandwidth so that it is also a low cost approach; Fifth, it does not need a super fast computer for 3D image reconstruction.

As a result, even cost in a big AM machine could be very high but the cost of an add-on CT system for is very low.

This CT system using LDA continuously takes NDT data and monitors the object build health status during AM process.

If during AM process, computer determines that a defect is found, then depending application and defect grade, the computer has options to terminate this particular manufacturing for this object and start a new AM process. Therefore, precious resource can be saved.

The feature of 3D printing layer-by-layer, or 2D-to-3D manufacturing process and the feature of CT NDT with LDA layer-by-layer scan process could be a perfect match.

Furthermore, modern CT technology makes it possible for CT NDT method to select a optimum pixel size and speed so that CT NDT is always slightly faster than a 3D printing build without losing too much of details.

### SUMMARY OF THE INVENTION

Generally, the current invention relates to a system for producing three-dimensional (3D) objects, such as industrial casting cores, aerospace and automotive parts, architectural and medical models etc.

Additionally, the invention relates to a method that can also provide quality assurance of the additive manufacturing simultaneously during the build process.

In particular, the quality assurance method uses X-ray Computer Tomography (CT) with Linear Diode Array (LDA) have non-contact, non-destructive features and can be put into automation so that large volume of high quality objects can be produced.

LDA could have different pixel size to fit various needs and also length is highly scalable. So X-ray CT with LDA can be much easier integrated into a 3D printing system.

Either platform of 3D build or X-ray source/detector can be on a rotation and translational stage.

Using CT computer control, if defects are found in the part being built in-progress, this 3D printing process can be terminated in early stage; older part can be replaced and a new 3D printing process can be started.

### BRIEF DESCRIPTION OF THE DRAWINGS

FIG. 1 is a schematic of one embodiment of an apparatus for simultaneous 3D printing and NDT with CT using LDA in which the 3D platform stands still while source and linear X-ray detector rotate and move up-down together.

FIG. 2 is a schematic of an alternative embodiment of an apparatus for simultaneous 3D printing and NDT with CT using LDA in which the 3D printing platform rotates and source and detector move up-down.

FIG. 3 is a schematic of an alternative embodiment of an apparatus for simultaneous 3D printing and NDT with CT using LDA in which source and detector stand still while the 3D platform rotates and move up-down.

FIG. 4 is a schematic of an alternative embodiment of an apparatus for simultaneous 3D printing and NDT with CT using LDA in which the 3D printing platform moves up-down and source and detector rotate.

### DETAILED DESCRIPTION OF THE INVENTION

The present invention is a method to perform simultaneous 3D printing and X-ray NDT. The system to perform the method comprises X-ray source 1, X-ray beam collimation 2, X-ray linear detector 4, 3D printer head 5, 3D print object 6, 3D print platform 7.

Depending on different working modes, there are rotational and translational motion control mechanisms. X-ray source 1, X-ray beam collimation 2, X-ray linear detector 4 share the same rotational and translational motion control while 3D printer head 5, 3D print object 6, 3D print platform 7 are in a separate rotational and translational motion control system.

X-ray beam collimation 2, X-ray linear detector 4 align with 3D print layers, X-ray linear detector 4 can also have a curved geometry. Length of X-ray linear detector 4 is enough to cover 3D part. Width of X-ray beam collimation 2 slit is selected based on the pixel size of X-ray linear detector 4 in order to effectively reduce X-ray scatter. Pixel size of X-ray linear detector 4 depends on part defect detection requirement. Selection of X-Ray source KV and mA would depend on the nature of 3D build material and NDT speed requirements.

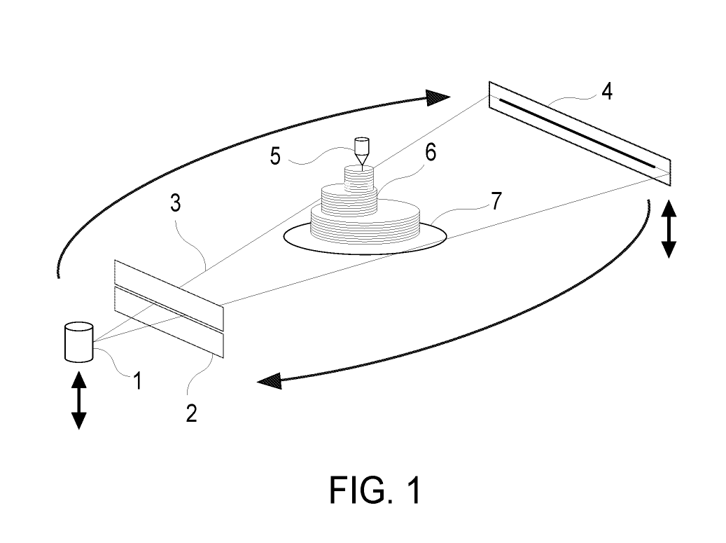

Referring to FIG. 1, this set-up is one of popular working mode. 3D printer head 5, 3D print object 6, 3D print platform 7 stand still while X-ray source 1, X-ray beam collimation 2 and X-ray linear detector 4 can rotate together and move up-down together.

During 3D build, material like metal, plastics etc will be locally melt with high temperature so a standstill platform will make material formation more stable. In this working mode, all the motion control only applies to source and detectors.

Motion increments are aligned with 3D build increment layer.

Rotation of X-ray source 1, X-ray beam collimation 2 and X-ray linear detector 4 will generate detailed image projection data. While 3D build is going on, data from X-ray linear detector 4 is transferred to a computer. This computer can do CT image reconstruction and visualization.

Because mechanical process of 3D build is always slower than electronic process of X-ray detector, so data redundancy is guaranteed. Good data redundancy will help detecting defects.

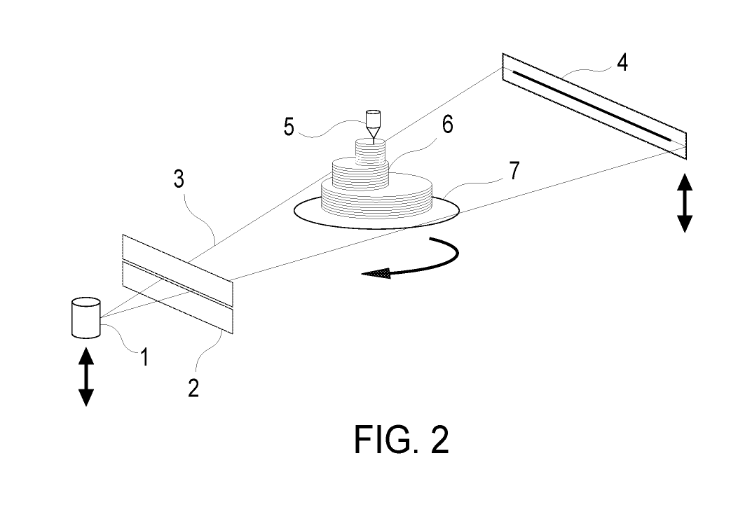

FIG. 2 shows another working mode. 3D printing platform 7 rotates and X-ray source 1 and X-ray linear detector 4 move up-down.

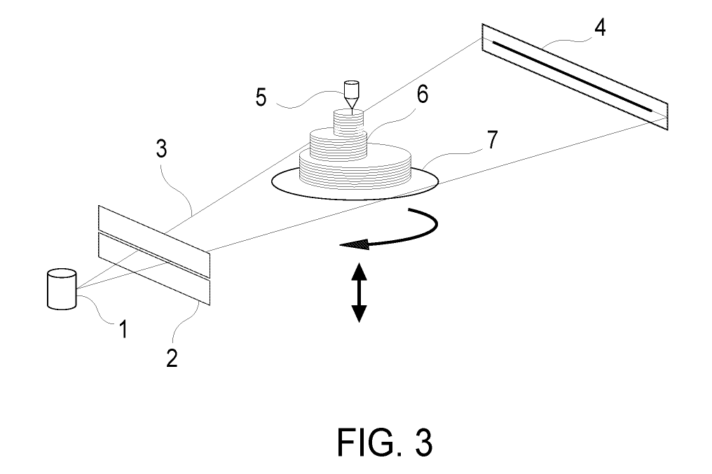

FIG. 3 shows yet another working mode. X-ray source 1 and X-ray linear detector 4 stand still and 3D print platform 7 rotates and move up-down.

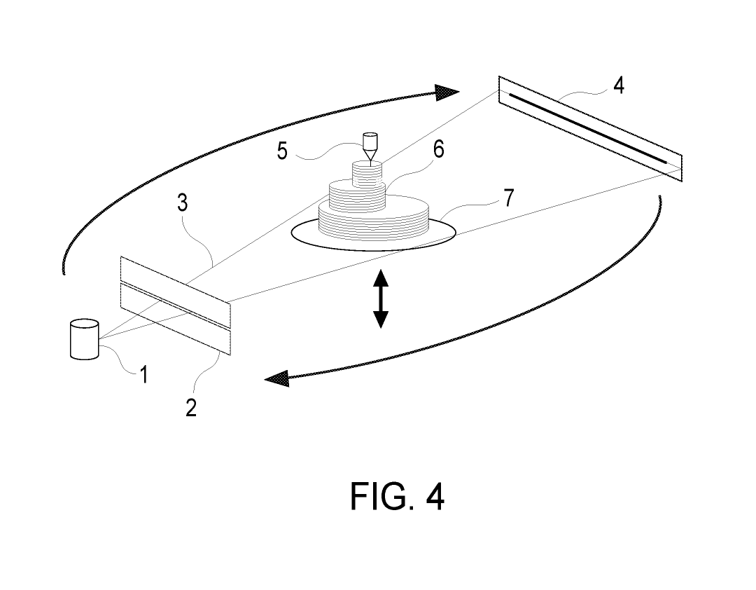

FIG. 4 shows still another working mode. 3D printing platform 7 move up-down and X-ray source 1 and X-ray linear detector 4 rotates.

Although the invention has been described above with reference to one or more preferred functioning modes, variations or modifications may exist without departing from the scope of the invention as defined in the claims.

I claim:

1. An method of Simultaneous 3D printing and NDT with Computer Tomography using LDA, the method compromising:
operating an additive manufacturing system or 3D printing system to perform a build process by building a part on a build platform, the part being built by forming a series of layers of material on the build platform, the material melting and solidifying during the build process thereby creating internal defects in the part;
during the build process, using one or plurality of X-ray generators and one or plurality of LDAs to generate X-ray CT imaging data of the part;
storing the X-ray CT imaging data in a data logger to provide stored imaging data in the data logger, and
analyzing the stored CT imaging data to determine whether a defect has formed during the build process, the method further comprising generating a warning if the analysis of the stored imaging data concludes that a defect has formed during the build process, wherein the warning includes an indication of a position in the part.

2. Apparatus for performing the method of claim 1, the apparatus comprising:
a build platform to build a part;
an additive manufacturing system which can be operated to perform the build process;
a X-ray fan beam CT system with X-ray generator, LDA X-ray detector, translational and rotational motion control system, image reconstruction and visualization software to generate CT image data of the part;
a data logger for storing the CT image data to provide stored CT image data in the data logger, and
an analysis tool configured to analyse the stored CT image data to determine whether a defect has formed during the build process, and to generate a warning if the analysis of the stored CT image data concludes that a defect has formed during the build process, wherein the warning includes an indication of a position and a size in the part.

3. The method of claim 1 wherein the indication of a position in the part indicates an X, Y and Z location of the part.

4. The apparatus of claim 2, wherein either object build platform or assembly of X-ray generator and LDA detector is on a motion control.

5. The apparatus of claim 2 wherein X-ray detector is either single line LDA or multi line LDA.

6. The apparatus of claim 2 wherein number of X-ray generator and X-ray LDA detector is with either single piece or a plurality of pieces.

7. The apparatus of claim 2 wherein there is a sub-structure to stop build process.

8. Apparatus of claim 2 there is a sub-structure to remove the old part and mount a new part.
